(19) United States
(12) Patent Application Publication
(10) Pub. No.: US 2015/0039414 A1
(43) Pub. Date: Feb. 5, 2015

(54) SYSTEM AND METHOD FOR ISSUING ONLINE REWARDS

(71) Applicant: Kwangl Ltd., Hong Kong (CN)

(72) Inventor: Matthew Alexander Edgley, Stockport (GB)

(21) Appl. No.: 14/338,014

(22) Filed: Jul. 22, 2014

(30) Foreign Application Priority Data
Jul. 30, 2013 (GB) 1313628.8

(51) Int. Cl. G06Q 30/02; G06F 17/30; G06Q 50/00

(52) U.S. Cl. CPC G06Q 30/0239; G06Q 50/01; G06Q 30/0269; G06F 17/30867
USPC 705/14.39

(57) ABSTRACT

The system and method for issuing an online reward disclosed provides a direct way to specifically reward a user for their actions on the internet. For a campaign according to the system and method, a unique code is provided, which could, for example, be a hashtag, and a search of pre-defined internet websites is performed for the unique code. Where the unique code is found on one or more of the pre-defined internet websites, the user associated with that code is validated by checking if the user is in a list of pre-defined users and, if they are approved, a reward is issued to the user.

### FIELD OF THE INVENTION

The present invention generally relates to a system and method for issuing rewards based on user participation in an online advertising campaign.

### BACKGROUND TO THE INVENTION

The internet is ubiquitous across a large number of the world's population. Increasingly, a company's online profile is related to its presence on social media websites and its interaction with the users of those websites.

For example, if a Facebook® user ‘likes’ a company's website, that fact can be distributed to the users ‘friends’ on Facebook®, increasing the amount of people that the company is reaching, especially if it generates further ‘likes’ as a result. In a similar manner, a Twitter® user may add a status or ‘tweet’ to their profile on Twitter® which can then be viewed by anyone who looks at their profile and is automatically distributed to anyone who follows the user. A company's online reach can be increased by having an increased amount of Twitter® followers or by encouraging other Twitter® users to post tweets about the company, such as, for example, using a pre-defined ‘hashtag’. A hashtag is a form of metadata and provides a means of grouping messages on social media websites. For example, on Twitter®, any message that contains the same hashtag can be read together by searching for that hashtag.

Therefore, there is a particular advantage to a company in promoting a product or themselves by having users of social media websites interact in a manner which results in further users becoming aware of the product. At present, it is difficult to encourage users to independently discuss or post about a product or company. Two common ways to attempt to encourage this discussion or posting is through unusual videos or adverts (viral marketing) or through the use of competitions which require posting or discussion. In the case of viral marketing, there is no particular benefit to the user but, in the case of competitions, it can be difficult to provide benefit to more than a few users.

Providing vouchers to potential buyers of a product or products which provide a benefit of some kind, is a common marketing strategy both online and offline but reliably providing vouchers as a reward to a user in an internet world can be problematic.

The present invention ameliorates or mitigates the limitations of present internet based reward voucher systems and methods and provides other benefits as will become clearer to those skilled in the art from the foregoing description.

### SUMMARY OF THE INVENTION

According to a first aspect of the present invention there is provided a method for issuing online rewards including:
a. retrieving from a data store data associated with at least one reward campaign the data including at least one pre-defined website, at least one campaign code and a predefined list of users, or details to allow access to one or more lists of users to generate a predefined list of users;
b. searching the or each pre-defined website for one or more of the or each campaign codes and returning a list of results;
c. for each result of list of results returned in the searching step, establishing a user associated with the result and determining whether the user exists in the predefined list of users; and,
d. for each user identified as existing in the predefined list of users, issuing the user with a reward.

According to a second aspect of the present invention there is provided a system for issuing online rewards comprising:
a. a data store including data associated with one or more reward campaigns, the data including at least one pre-defined website, at least one campaign code and a predefined list of users, or details to allow access to one or more lists of users to generate a predefined list of users;
b. a communications link capable of connecting to the list of pre-defined websites; and
c. a computer processor programmed to search the or each pre-defined website for one or more of the or each campaign codes and receive a list of results, for each result of list of results returned in the search, establishing a user associated with the result and determining whether the user exists in the predefined list of users, and, for each user identified as existing in the predefined list of users, issuing the user with a reward.

The reward system and method of the present invention provides a direct way to specifically reward a user for their actions on the internet. For a reward campaign according to the invention, a unique code is provided, which could, for example, be a hashtag, and a search of pre-defined internet websites is performed for the unique code. Where the unique code is found on one or more of the pre-defined internet websites, the user associated with that code is validated by checking if the user is in a list of pre-defined users and, if they are approved, a reward is issued to the user.

The list of pre-defined users may be dependent on the type of reward campaign. For example, if the reward campaign includes the Twitter® social media website in its list of pre-defined internet websites, then the pre-defined users may include a list of users which ‘follow’ a pre-defined Twitter® account. Similarly, if the Facebook® social media website is included in the list of pre-defined internet websites, then the pre-defined users may include a list of users which ‘like’ a pre-defined Facebook® account or page.

### BRIEF DESCRIPTION OF THE DRAWINGS

Preferred embodiments of the invention will now be described, by way on non-limiting example only, with reference to the accompanying drawings, in which:

FIG. 1 shows a schematic diagram of a system for issuing online rewards; and

FIG. 2 shows a flow diagram of a method for issuing online rewards.

### DETAILED DESCRIPTION

A preferred embodiment of the invention is now described in detail. Referring to the drawings, like numbers indicate like parts throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise.

A typical embodiment of the present invention will include a data store including one or more reward campaigns, a communications link capable of connecting to a list of pre-defined computer servers associated with a list of pre-defined websites, and a processor. The processor performs the tasks of storing the reward campaign details, including one or more pre-defined websites, one or more pre-defined campaign codes and a predefined list of users, or details to allow access to a one or more predefined lists of users to generate a predefined list of users, in the data store, searching the or each pre-defined website for one or more of the or each pre-defined campaign codes, for each result of the searching step, establishing a user associated with the result, determining whether the user exists in the predefined list of users and, if the user does exist in the predefined list of users, issuing the user with a reward.

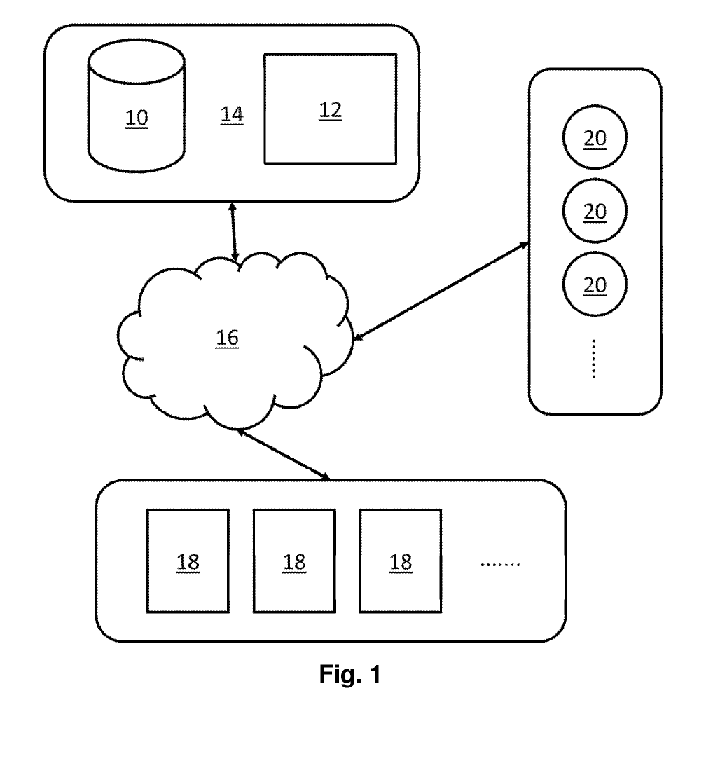

In a preferred embodiment, as exhibited by FIG. 1, a data store 10 and a processor 12 are shown as part of a computer system 14. The data store 10 may comprise multiple data stores as required by the system 14 and the processor 12 may comprise multiple processors as required by the system 14. The data store 10 may be implemented through a database system, which may be distributed amongst multiple computers. The Internet 16 serves as a communication link for the computer system 14. Via the internet 16, the system 14 can access one or more internet web sites 18 and can interact with, such as by email or other forms of contact, users 20.

The tasks performed by the processor 12 may utilize a variety of underlying software technology. For example, the processor 12 may execute a computer application written in a computer language, such as Java® or PHP (which stands for PHP: Hypertext Preprocessor—a recursive acronym), which may be interpreted into instructions for the processor using an operating system, such as UNIX or Windows®.

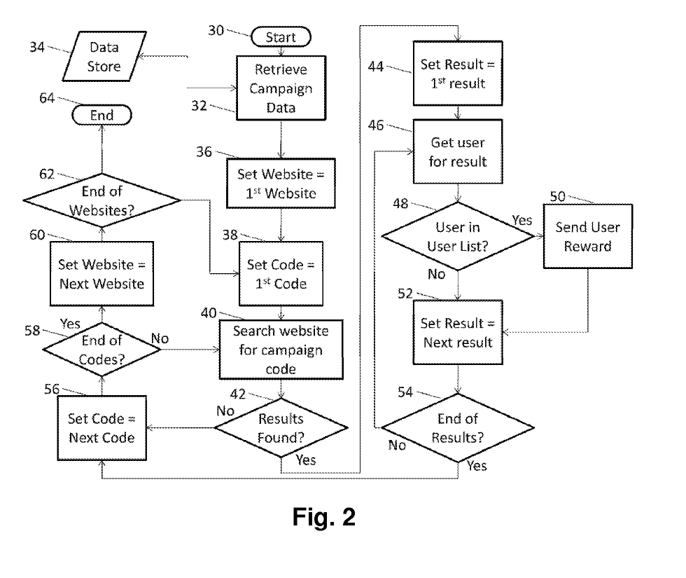

Referring now to FIG. 2, a flow diagram of a method of issuing online rewards is shown. Firstly, the method is initiated at step 30. The method may be initiated, in a computer implementation, on a regular basis, for example at a particular time each week, or on a one off basis, depending on the requirements of the campaign. Once initiated, in a data retrieval step 32, campaign data is retrieved from a data store 34 for a particular campaign.

The campaign data includes at least one target website and, preferably, includes a plurality of target websites. Examples of websites suitable for this method are social media websites which allow for user participation, such as Twitter®, Tumblr®, Instagram®, Flickr®, Google+® and Facebook®. The website requires to be searchable. The campaign data also includes at least one code. Each code may be associated with one website or may be associated with a plurality of the websites targeted by the campaign. In addition, the campaign data includes one or more accounts or pages relating to the websites which is associated with the campaign target. For example, if the campaign target is a particular company's product, then the product may have a Twitter® account and a Facebook® page, the details of which would be included in the campaign data. Alternatively, the campaign data may simply include details of users registered for this particular campaign.

Once the campaign data has been retrieved, a list of websites is available and the first of those websites is selected (step 36). Then, a list of codes associated with that first website is selected (step 38).

The list of codes can be any code which can be searched on the relevant website. For popular social media sites, as discussed above, a metatag known as a ‘hashtag’ is commonly used as a grouping function. A hashtag is, typically, the ‘#’ character followed by text (or possibly other characters) without any spaces (or other ‘whitespace’ characters). Therefore, in this context, a hashtag can be used as a code for relevant websites. It is also possible to use other code types, however, such as a unique number or string of characters, as required by the relevant website or campaign.

The selected website is then searched for the selected code (step 40). The next step, step 42, checks if any results were found and, if so, the first result is selected (step 44). The selected result has an associated user and that user is retrieved (step 46). The retrieved user is then compared with a pre-defined user list (step 48) to see if they are on the user list.

The list is pre-defined in that either the list has been stored with the campaign data or the users are retrieved from a secondary source based on campaign data. If the list is retrieved from a secondary source, information such as usernames, passwords and other relevant data may be stored in the campaign data. One example of a list being generated from a secondary source is a list of followers of a particular twitter account. In this case, the twitter account details would be stored in the campaign data to allow step 46 to be completed by retrieving the list of followers.

If the retrieved user is found on the pre-defined user list then, in step 50, is issued with a reward. The reward may be, for example, in the form of a voucher which provides either a whole or partial reduction in the purchase of one or more products or services. Alternatively, the reward provides “points” or other collectable scores or value items which may be redeemable either wholly or partially in the purchase of one or more products or services. The reward, however, is not limited to being used against the whole or partial purchase of a product or service and may be, for example, points towards a game score. The reward can be a voucher with a unique or trackable aspect. For example, the reward may be in the form of an email voucher which contains a link coded for the particular user to which the reward is being issued. In this manner, it is possible to ensure that a reward is only redeemed once and also log whether the reward is redeemed at all.

The reward may be communicated to the user by any suitable means, such as, for example, email, Facebook message, Twitter post, Twitter direct message, letter etc.

If a user is not found in step 48, the next result in the returned results in selected in step 52. If the end of the results has not been reached (step 54), then steps 44 to 52 are repeated with the next result. This loop is repeated with all the results that have been returned.

If the end of the results has been reached (step 54), then the next code is selected (step 56). At step 58, it is checked whether all the codes for this website have been processed and, if not, steps 40 to 56 are repeated. If all the codes have been processed (step 58), then the next website is selected (step 60) from the list of websites in the campaign. At step 62, it is checked whether all the websites for this campaign have been processed and, if not, steps 38 to 60 are repeated. Finally, if all the websites have been processed, step 64 finishes the method.

The campaigns that can be utilised by the method and system disclosed herein are wide and varied. As an example, a television advert could indicate that use of the hashtag ‘#fingerlickingood’ on twitter by followers of a KFC® Twitter® account, such as ‘@kfc_colonel’ will result in a reward in the form of a discount code for a reduction in price for a particular product. A Twitter® user who views this advert can then choose to follow ‘@kfc_colonel’ and then publish a tweet that contains the hashtag ‘#fingerlickingood’. The method and system disclosed herein would then search Twitter® and find all Twitter® users who used the ‘#fingerlickingood’ hashtag and then check which of those users follows ‘@kfc_colonel’. Each of the users that meets both criteria is then issued with a reward as discussed above.

Modifications and improvements may be made without departing from the scope of the present invention.

1. A method for issuing online rewards including:
a. retrieving from a data store data associated with at least one reward campaign the data including at least one pre-defined website, at least one campaign code and a predefined list of users, or details to allow access to one or more lists of users to generate a predefined list of users;
b. searching the or each pre-defined website for one or more of the or each campaign codes and returning a list of results;
c. for each result of list of results returned in the searching step, establishing a user associated with the result and determining whether the user exists in the predefined list of users; and,
d. for each user identified as existing in the predefined list of users, issuing the user with a reward.

2. A method as claimed in claim 1, wherein the reward is one or more of the following:
a. a voucher which provides either a whole or partial reduction in the purchase of one or more products or services;
b. points or other collectable scores or value items which may be redeemable either wholly or partially in the purchase of one or more products or services; or
c. points towards a game score.

3. A method as claimed in claim 1, wherein the at least one campaign code is at least one unique code identifiable with the at least one reward campaign.

4. A method as claimed in claim 3, wherein the at least one unique code is at least one metatag recognizable by the at least one pre-defined website.

5. A method as claimed in claim 4, wherein the at least one metatag is a hashtag.

6. A method as claimed in claim 1, wherein the or each pre-defined website is a social networking website, capable of allowing users to submit user data to the social networking website.

7. A method as claimed in claim 6, wherein the method includes identifying the user data on the social networking website.

8. A method as claimed in claim 1, wherein the pre-defined list of users is a list of users that are registered to receive rewards.

9. A method as claimed in claim 8, wherein the pre-defined list of users includes user data which includes details of the user's respective user details on the at least one pre-defined website.

10. An system for issuing online rewards comprising:
a. a data store including data associated with one or more reward campaigns, the data including at least one pre-defined website, at least one campaign code and a predefined list of users, or details to allow access to one or more lists of users to generate a predefined list of users;
b. a communications link capable of connecting to the list of pre-defined websites;
c. a computer processor programmed to search the or each pre-defined website for one or more of the or each campaign codes and receive a list of results, for each result of list of results returned in the search, establishing a user associated with the result and determining whether the user exists in the predefined list of users; and,
d. for each user identified as existing in the predefined list of users, issuing the user with a reward.

11. A system as claimed in claim 10, wherein the at least one campaign code is at least one unique code identifiable with the at least one reward campaign.

12. A system as claimed in claim 11, wherein the at least one unique code is at least one metatag recognizable by the at least one pre-defined website.

13. A system as claimed in claim 12, wherein the at least one metatag is a hashtag.

14. A system as claimed in claim 10, wherein the or each pre-defined website is a social networking website, capable of allowing users to submit user data to the social networking website.

15. A system as claimed in claim 14, wherein the computer processor is programmed to search for user data on the social networking website.

16. A system as claimed in claim 10, wherein the pre-defined list of users is a list of users that are registered to receive rewards.

17. A system as claimed in claim 16, wherein the pre-defined list of users includes user data which includes details of the user's respective user details on the at least one pre-defined website.

18. A system as claimed in claim 10, wherein the processor issues the user with a reward by sending an electronic message to the user.

19. A system as claimed in claim 10, wherein the processor, communications link and data store are further combined to provide a website accessible by a plurality of users.
